(19) United States
(12) Patent Application Publication
(10) Pub. No.: US 2011/0011989 A1
(43) Pub. Date: Jan. 20, 2011

(54) Holder for flexible elongate conduits

(76) Inventor: Carla Samolej, Bolingbrook, IL (US)

Correspondence Address: MCCRACKEN & FRANK LLP, 311 S. WACKER DRIVE, SUITE 2500, CHICAGO, IL, 60606, US

(21) Appl. No.: 12/460,405

(22) Filed: Jul. 17, 2009

(51) Int. Cl. F16L 3/12

(52) U.S. Cl. 248/74.3

(57) ABSTRACT

A holder for securing flexible elongate conduits to a post includes a first holding member defined by first and second arms that extend from a first base and a second holding member defined by third and fourth arms that extend from a second base. The first and second bases are attached to one another. A first plane generally bisects the first holding member and is generally equidistant from the first and second arms along an entire longitudinal extent of the first holding member. A second plane generally bisects the second holding member and is generally equidistant from the third and fourth arms along an entire longitudinal extent of the second holding member. The first and second planes are generally perpendicular.

### CROSS REFERENCE TO RELATED APPLICATIONS

Not applicable.

### REFERENCE REGARDING FEDERALLY SPONSORED RESEARCH OR DEVELOPMENT

Not applicable

### SEQUENTIAL LISTING

Not applicable

### FIELD OF THE INVENTION

The present invention relates generally to a device for retaining flexible elongate conduits, such as tubes, wires, cables, hoses, and the like, and particularly to a device for retaining flexible elongate conduits by attaching same to a rail or post.

### BACKGROUND

In many applications, it is often important that groups of flexible elongate conduits, such as tubes, wires, cables, hoses, and the like be securely held. For example, improperly secured wires or hoses in a moving environment may chafe against one another and develop shorts or leaks. In a hospital setting, a jumble of flexible elongate conduits around a patient's bed may be a safety hazard to the patient and/or to caregivers. For example, tubes carrying important fluids or oxygen may get caught, crimped, broken, and/or pulled out or off of a patient, and possibly developing a flow restriction and preventing flow of such fluids or oxygen to the patient. In addition, any tube or wire within a disorganized bundle of tubes can be difficult to trace, thereby preventing a caregiver from finding a particular tube or wire in a timely fashion. Devices are known for securing bundles of flexible elongate conduits or other objects to one another or to a surface.

One such device is a double ended clip having oppositely disposed pairs of clip arms that extend from a common base and lie in a common plane. Each pair of clip arms has generally circular openings that are graduated in size with a large opening nearest distal ends of the arms and a small opening nearest the base. The distal ends of each pair of clip arms extend away from one another. Items with different generally circular cross sections may be held within the openings such that the items are generally parallel to one another.

Another device has two or more jaws, each jaw including opposing upper and lower jaw members. Each jaw has a flexible hinge that connects the upper jaw member to the opposing lower jaw member, wherein the flexible hinges are connected by struts. Teeth are disposed on facing surfaces of the opposing jaw members to clamp and retain items therein. The jaws are oriented such that each jaw defines a channel having a centerline and the centerlines lie in planes that are generally parallel.

A further device has an elongate flat plastic base having a wide central region and narrow ends extending from a first edge of the central region. Hook and loop fasteners are attached around the narrow ends to affix the base to a hospital bed rail. A rib extends longitudinally along a bottom side of the base between the narrow ends to provide added stability. The wide central region includes a number of apertures of different sizes disposed therethrough to accommodate medical implements and accessories. A tube holder is attached via a hook and loop fastener to a top surface of one of the narrow ends. The tube holder includes a top jaw that may be pivotally opened upwardly from or entirely removed from an opposing bottom jaw, wherein the top jaw is held closed against the opposing bottom jaw by a hook and loop fastener. Facing surfaces of the opposing jaws include a plurality of complementary semi-circular cavities of varying sizes that form circular apertures that may hold tubes therein when the opposing jaws are closed.

### SUMMARY

In one aspect of the present disclosure, a holder for securing flexible elongate conduits to a post includes a first holding member defined by first and second arms that extend from a first base and a second holding member defined by third and fourth arms that extend from a second base. The first and second bases are attached to one another. A first plane generally bisects the first holding member and is generally equidistant from the first and second arms along an entire longitudinal extent of the first holding member. A second plane generally bisects the second holding member and is generally equidistant from the third and fourth arms along an entire longitudinal extent of the second holding member. The first and second planes are generally perpendicular.

In another aspect of the present disclosure, a holder for securing flexible elongate conduits to a post includes a first holding member defined by first and second arms that extend from a first base and a second holding member defined by third and fourth arms that extend from a second base. The first and second bases are attached to one another. A first plane generally bisects the first holding member and is generally equidistant from the first and second arms along an entire longitudinal extent of the first holding member. A second plane generally bisects the second holding member and is generally equidistant from the third and fourth arms along an entire longitudinal extent of the second holding member, wherein the first and second planes are generally perpendicular. Each of the first and second arms includes mutually exclusive first and second segments, wherein the first segment is proximate to the first base and has a first thickness that is less than a second thickness of the second segment.

In a further aspect of the present disclosure, a holder for securing flexible elongate conduits to a post includes a first holding member defined by first and second arms that extend from a first base and a second holding member defined by third and fourth arms that extend from a second base. The first and second bases are attached to one another. A first plane generally bisects the first holding member and is generally equidistant from the first and second arms along an entire longitudinal extent of the first holding member. A second plane generally bisects the second holding member and is generally equidistant from the third and fourth arms along an entire longitudinal extent of the second holding member. The first and second planes are generally perpendicular. Each of the first and second arms includes mutually exclusive first and second segments, wherein the first segment is proximate to the first base and has a first thickness that is less than a second thickness of the second segment. The third and fourth arms taper in thickness from a third thickness proximate the second base to a fourth thickness proximate distal ends of the third and fourth arms, wherein the third thickness is greater than the fourth thickness.

### BRIEF DESCRIPTION OF THE DRAWINGS

FIG. 1 is an isometric view of a holder for flexible elongate conduits;

FIG. 2 is a front elevational view of the holder of FIG. 1, the rear elevational view being identical to the front elevational view;

FIG. 3 is a side elevational view of the holder of FIG. 1, an opposing side elevational view being identical to the side elevational view; and

FIG. 4 is an isometric view of the holder of FIG. 1 mounted on a rail.

Other aspects and advantages of the present disclosure will become apparent upon consideration of the following detailed description, wherein similar structures have similar reference numbers.

### DETAILED DESCRIPTION

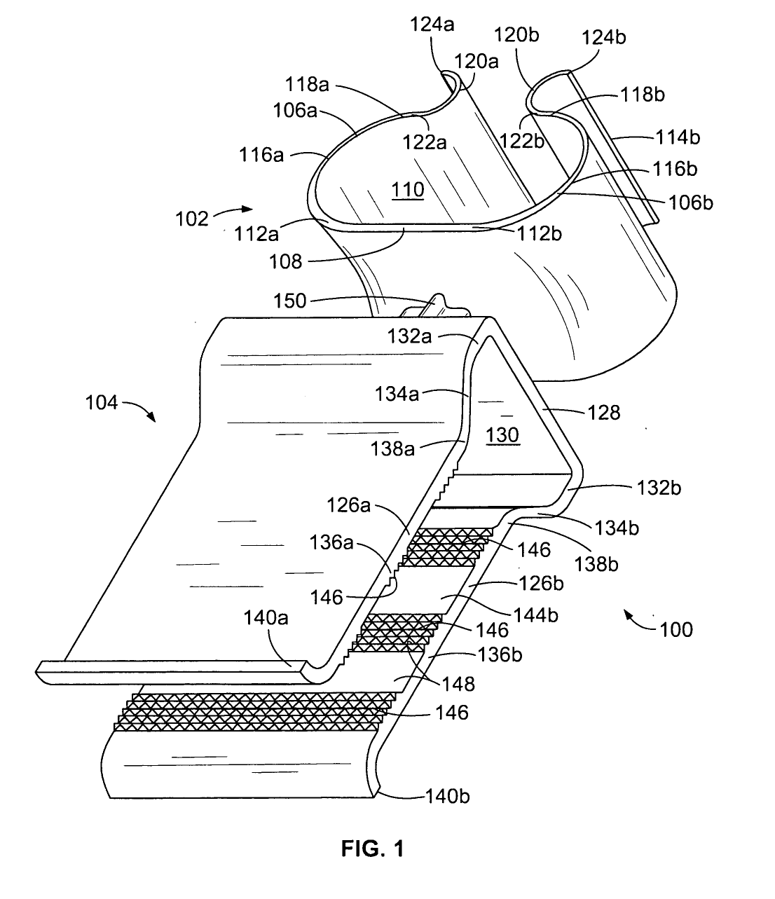

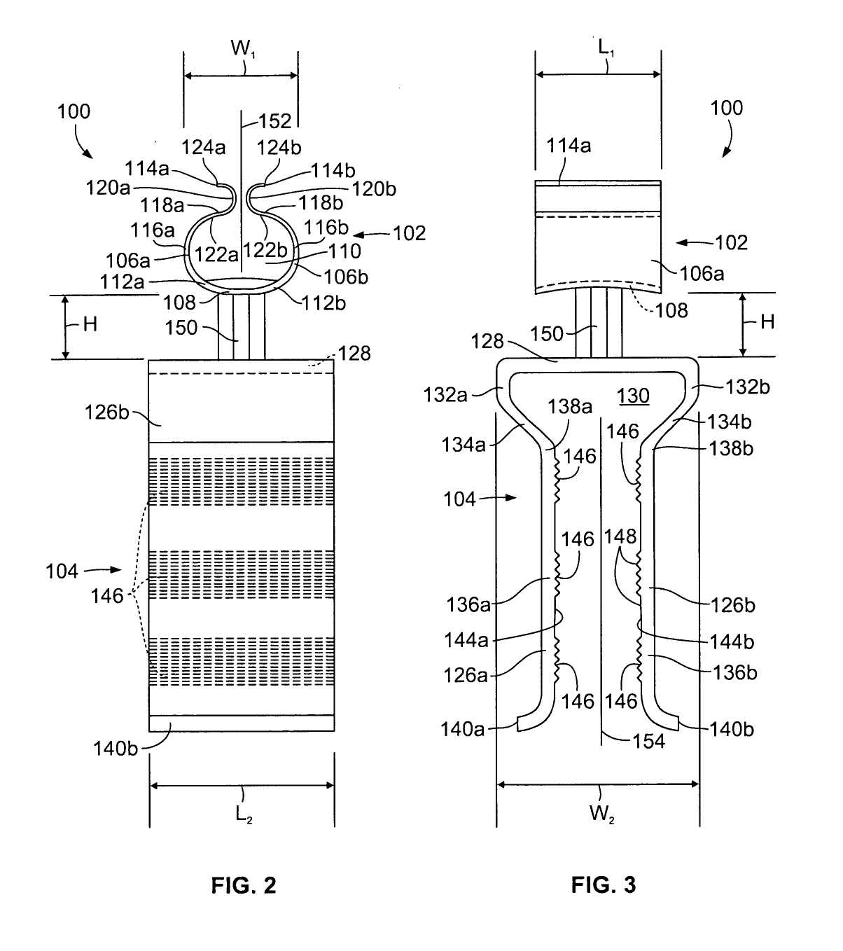

FIGS. 1-3 illustrate a holder 100 for flexible elongate conduits, wherein the holder 100 includes first and second holding members 102, 104. The first holding member 102 is defined by first and second resilient arms 106a, 106b that extend from a first base 108. The first and second arms 106a, 106b and first base 108 define a first channel 110 therebetween, as discussed in greater detail hereinafter. As best seen in FIG. 2, each of the first and second resilient arms 106a, 106b tapers in thickness from a first thickness at a base end 112a, 112b thereof to a second thickness at distal ends 114a, 114b thereof. The second thickness is preferably, although not necessarily, less than the first thickness. Each of the first and second resilient arms 106a, 106b also includes a first region 116a, 116b that has a generally semi-circular shape extending from the first base 108. Arcs forming the semi-circular shape of the first regions 116a, 116b bow outwardly such that distal ends 118a, 118b of the first regions 116a, 116b are oriented toward the distal end 118a, 118b of the other of the first and second arms 106a, 106b. The first and second arms 106a, 106b further include second regions 120a, 120b that have inboard ends 122a, 122b integral with the distal ends 118a, 118b, respectively, of the first regions 116a, 116b and distal ends 124a, 124b coincident with the distal ends 11 4a, 114b of the first and second arms 106a, 106b. The second regions 120a, 120b also have a generally semi-circular shape with arcs thereof bowing inwardly such that the distal ends 124a, 124b of the second regions 120a, 120b, respectively, extend away from one another.

Referring to FIG. 3, the first base 108 may be generally planar or may be non-planar, as illustrated. The first base 108 gently curves into the first regions 116a, 116b of the first and second arms 106a, 106b to accommodate flexible elongate conduits, such as tubes, wires, cables, hoses, and the like that may be supported by the first base 108 and held within the first channel 110.

As best seen in FIGS. 1 and 3, the second holding member 104 is defined by third and fourth arms 126a, 126b that extend from a second base 128 to form a second channel 130. Each of the third and fourth arms 126a, 126b includes a first segment 132a, 132b integral with and extending generally perpendicularly from the second base 128. A second flexible segment 134a, 134b connects each of the first segments 132a, 132b to a third segment 136a, 136b. The second flexible segments 134a, 134b preferably have a thickness that is less than a thickness of the first and third segments 132a, 132b and 136a, 136b. The second flexible segments 134a, 134b curve inwardly when the holder 100 is in an unattached state, as seen in FIGS. 1-3.

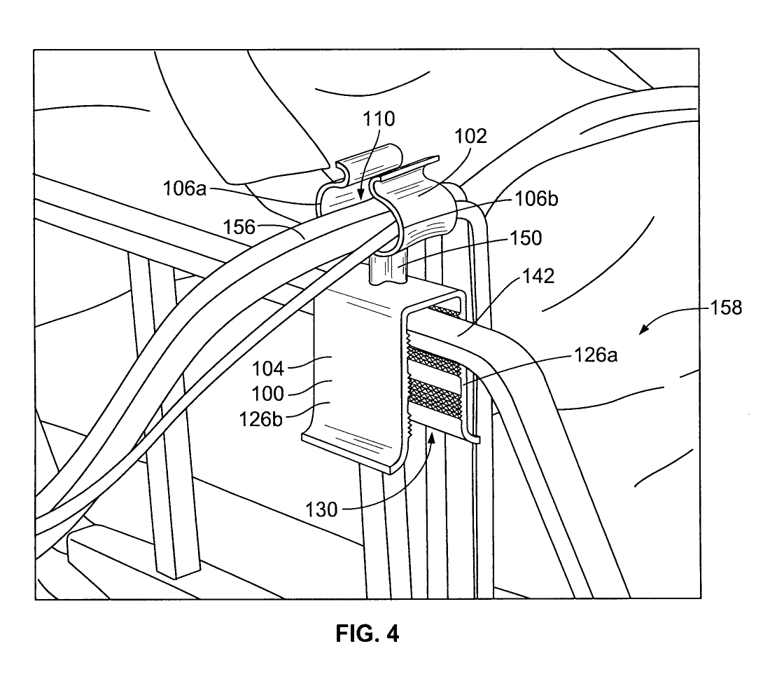

The third segments 136a, 136b are attached to distal ends 138a, 138b of the second flexible segments 134a, 134b and extend away from the second base 128 and are generally parallel with the first segments 132a, 132b. The third segments 136a, 136b of the third and fourth arms 126a, 126b lie in generally parallel planes when the holder 100 is in an unattached state, as seen in FIGS. 1-3. Distal ends 140a, 140b of each of the third and fourth arms 126a, 126b are oriented away from the other of the third and fourth arms 126a, 126b, as best seen in FIG. 3. Referring to FIG. 4, when the holder 100 is attached over a support member 142 (FIG. 4), for example a post or rail, the third and fourth arms 126a, 126b may expand to accommodate the support member 142, as will be discussed in greater detail hereinafter.

Referring to FIG. 3, inwardly facing planar surfaces 144a, 144b of one or both of the third segments 136a, 136b of the third and fourth arms 126a, 126b may include one or more textured portions 146, for example, knurling, at one or more locations thereon. For example, knurling is shown in FIG. 3 at three locations on each of the inwardly facing surfaces 144a, 144b. Any number of textured portions 146 or no textured portions 146 may be disposed on the surfaces 144a, 144b. The textured portions 146 may be molded into the surfaces 144a, 144b, may be added as a layer or film of material to the surfaces 144a, 144b, or may be embossed or etched into the surfaces 144a, 144b. The textured portions 146 may encompass a portion of one or both of the surfaces 144a, 144b or all of one or both of the surfaces 144a, 144b. At least one of the surfaces 144a, 144b may also be covered with a tacky coating 148 that may include a rubberized material or a material having greater compressibility than the material comprising the third and fourth arms 126a, 126b.

Referring to FIGS. 1-3, the first and second holding members 102, 104 are connected by a support member 150. Optionally, the support member may be removed, wherein the first and second bases 108, 128 would be formed integrally or otherwise connected to one another.

A first plane 152 generally bisects the first holding member 102 and is generally equidistant from the first and second arms 106a, 106b along an entire longitudinal extent of the first holding member 102, as illustrated in FIG. 2. A second plane 154 is generally parallel to the third segments 136a, 136b of the third and fourth arms 126a, 126b and generally bisects the second holding member 104. The second plane 154 is generally equidistant from the third and fourth arms 126a, 126b along an entire longitudinal extent of the second holding member 104, as illustrated in FIG. 3. The first and second planes 152, 154 are generally perpendicular to one another, the purpose of which is described in greater detail hereinafter. Although the first and second planes 152, 154 are depicted as lines in FIGS. 2 and 3, it should be understood that such planes extend into the paper such that only a cross sectional representation of each plane 152, 154, i.e., a line, is visible.

As illustrated in FIG. 4, the holder 100 may be attached to the support member 142, which is depicted in FIG. 4 as a bed rail 142. To attach the holder 100 to the bed rail 142, the holder 100 is oriented such that the third and fourth arms 126a, 126b are disposed above the bed rail 142 and the third and fourth arms 126a, 126b are lowered to make contact with the bed rail 142. The outwardly oriented distal ends 140a, 140b facilitate guiding the third and fourth arms 126a, 126b into proper alignment with the bed rail 142. Upon making contact with and pushing down on the bed rail 142, the second segments 134a, 134b and the third segments 136a, 136b of the third and fourth arms 126a, 126b expand outwardly from one another to widen the second channel 130 and accommodate the bed rail 142. The outward expansion of the third and fourth arms 126a, 126b is facilitated by flexibility of the second flexible segments 134a, 134b, which can elastically and flexibly transition from an unattached state as illustrated in FIG. 3 to an attached state as illustrated in FIG. 4. The flexibility of the second flexible segments 134a, 134b also allows the holder 100 to be attached to rails and/or posts of varying thickness. The holder 100 is securely held on the bed rail 142 by the force of elasticity of the second flexible segments 134a, 134b transmitted to the bed rail 142 via the third and fourth arms 126a, 126b. The texture 146 and/or the tacky coating 148 on the inwardly facing surfaces 144a, 144b of the third and fourth arms 126a, 126b, respectively, further facilitate securing and retaining the holder 100 on the bed rail 142. The holder 100 may easily be removed from the bed rail 142 by simply pulling the third and fourth arms 126a, 126b upwardly and/or outwardly relative to the bed rail 142.

As seen in FIG. 4, the holder 100 attached to the bed rail 142 by the third and fourth arms 126a, 126b provides a convenient guide for orienting and holding one or more flexible elongate conduit(s) 156 that may supply power, fluids, and/or other necessities to a patient in a bed 158 from equipment (not shown) disposed around the bed 158. In particular, the orientation of the first plane 152 generally perpendicular to the second plane 154 facilitates an orientation for the flexible elongate conduit(s) 156 that is over and across the bed rail 142 when the third and fourth arms 126a, 126b are attached to the bed rail 142. This orientation prevents the flexible elongate conduit(s) 156 from being bent, falling into cracks or below the bed rails, etc. Further, the convex curvature of the first base 108 accommodates the natural tendency for the flexible elongate conduit(s) 156 to flexibly hang from a support point such as the first base 108. Stress on the flexible elongate conduit(s) 156 at the first base 108 is thereby minimized, thus diminishing the possibility of chafing, crimping, or breakage of the flexible elongate conduit(s) 156. The first base 108 also facilitates organization of the flexible elongate conduit(s) 156 being held thereby, which may make a caregiver's job easier in tracing flexible elongate conduit(s) 156 from a supply point outside of the bed 158 to the patient lying in the bed 158. Organization of the flexible elongate conduit(s) 156 through the holder 100 also prevents the possibility of the caregiver, a visitor, or a patient from tripping over or otherwise disturbing the flexible elongate conduit(s) 156 that may otherwise be haphazardly distributed between the bed 158 and the room.

As technology applied to medicine continues to advance, more apparatus involving a greater number of connections for delivery of power and/or fluids are being used in patient care. The holder 100, described hereinabove provides a simple and elegant solution for safely and efficiently managing the connections. The holder 100 may be molded, stamped, or otherwise manufactured from metal, plastic, ceramic, or other material as a unitary construction.

Alternatively, the holder 100 may be manufactured as individual components that are attached to one another in a post-manufacture process. Such manufacture of individual components facilitates the manufacture of customized holders for flexible elongate conduits having predetermined sizes for the first and second channels 110, 130. For example, the support member 150 and the first and second holding members 102, 104 may be manufactured independently from one another. The support member 150 may therefore be manufactured in varying predetermined heights as defined by a distance H illustrated in FIGS. 2 and 3 between the first and second bases 108, 128 to provide a separation distance as desired between the first and second bases 108, 128 when attached together by the support member 150. Similarly, the first holding member 102 may be manufactured in varying predetermined lengths as defined by a longitudinal distance L₁, as illustrated in FIG. 3, and the second holding member 104 may be manufactured in varying predetermined lengths as defined by a longitudinal distance L₂, as illustrated in FIG. 2. Further, the first and second holding members 102, 104 may be manufactured in varying predetermined widths W₁ and W₂, respectively, as illustrated in FIGS. 2 and 3. Thus the sizes of the first and second holding members 102, 104 as well as the support member 150 may be tailored and combined for use in specific applications as desired.

### INDUSTRIAL APPLICABILITY

A device that securely holds flexible elongate conduits and may be attached to a rail or post has been presented. First and second arms of the device define a first holding member and third and fourth arms define a second holding member. A first plane bisects the first holding member and is generally equidistant between the first and second arms along an entire longitudinal extent of the first holding member. A second plane bisects the second holding member and is generally equidistant between the third and fourth arms along an entire longitudinal extent of the second hooding member. The second plane is generally perpendicular to the first plane. The first and second arms may be elastically attached over the rail such that flexible elongate conduits supported by the third and fourth arms may be safely oriented in an organized fashion across the rail.

Numerous modifications to the present disclosure will be apparent to those skilled in the art in view of the foregoing description. Accordingly, this description is to be construed as illustrative only and is presented for the purpose of enabling those skilled in the art to make and use the disclosure and to teach the best mode of carrying out same. The exclusive right to all modifications within the scope of the impending claims is expressly reserved. All patents, patent publications and applications, and other references cited herein are incorporated by reference herein in their entirety.

I claim:

1. A holder for securing flexible elongate conduits to a post, comprising:
a first holding member defined by first and second arms that extend from a first base;
a second holding member defined by third and fourth arms that extend from a second base, wherein the first and second bases are attached to one another;
a first plane that generally bisects the first holding member and is generally equidistant from the first and second arms along an entire longitudinal extent of the first holding member; and
a second plane that generally bisects the second holding member and is generally equidistant from the third and fourth arms along an entire longitudinal extent of the second holding member, wherein the first and second planes are generally perpendicular.

2. The holder of claim 1, wherein the first and second arms taper in thickness from a first thickness proximate the first base to a second thickness proximate distal ends of the first and second arms.

3. The holder of claim 2, wherein the first thickness is greater than the second thickness.

4. The holder of claim 1, wherein each of the first and second arms includes a generally semi-circular region having a first end attached to the first base and a second end oriented toward the other arm with an arc of the semi-circular region directed outward.

5. The holder of claim 4, wherein each of the first and second arms includes a second region having a third end attached to the second end of the generally semi-circular region and a distal end oriented away from a distal end of the other arm.

6. The holder of claim 1, wherein the first base is non-planar.

7. The holder of claim 6, wherein the first base includes a surface that is convex on a side facing away from the third and fourth arms.

8. A holder for securing flexible elongate conduits to a post, comprising:
a first holding member defined by first and second arms that extend from a first base;
a second holding member defined by third and fourth arms that extend from a second base, wherein the first and second bases are attached to one another;
a first plane that generally bisects the first holding member and is generally equidistant from the first and second arms along an entire longitudinal extent of the first holding member; and
a second plane that generally bisects the second holding member and is generally equidistant from the third and fourth arms along an entire longitudinal extent of the second holding member;
wherein the first and second planes are generally perpendicular and each of the first and second arms includes mutually exclusive first and second segments, wherein the first segment is proximate to the first base and has a first thickness that is less than a second thickness of the second segment.

9. The holder of claim 8, wherein the first segment of each of the first and second arms extends from a base and each of the second segments extends inwardly toward the other second segment when in an unattached state.

10. The holder of claim 9, wherein third segments of the first and second arms lie in third and fourth planes, respectively, that are generally parallel when the holder is in an unattached state.

11. The holder of claim 10, wherein each of the second segments of move outwardly when in an attached state.

12. The holder of claim 8, wherein at least one of the third segments of the first and second arms includes knurling on a surface thereof facing the other third segment.

13. The holder of claim 8, wherein facing surfaces of third segments of the first and second arms include a tacky coating thereon.

14. The holder of claim 8, wherein a distal end of each of the first and second arms is oriented away from the other arm.

15. A holder for securing flexible elongate conduits to a post, comprising:
a first holding member defined by first and second arms that extend from a first base;
a second holding member defined by third and fourth arms that extend from a second base, wherein the first and second bases are attached to one another;
a first plane that generally bisects the first holding member and is generally equidistant from the first and second arms along an entire longitudinal extent of the first holding member; and
a second plane that generally bisects the second holding member and is generally equidistant from the third and fourth arms along an entire longitudinal extent of the second holding member;
wherein the first and second planes are generally perpendicular, each of the first and second arms includes mutually exclusive first and second segments, wherein the first segment is proximate to the first base and has a first thickness that is less than a second thickness of the second segment, and the third and fourth arms taper in thickness from a third thickness proximate the second base to a fourth thickness proximate distal ends of the third and fourth arms and wherein the third thickness is greater than the fourth thickness.

16. The holder of claim 15, wherein each of the third and fourth arms includes a generally semi-circular region having a first end attached to the second base and a second end oriented toward the other of the third and fourth arms with an arc of the semi-circular region directed outward and the first segment of each of the first and second arms extends from a base end thereof toward the other of the first and second arms.

17. The holder of claim 16, wherein each of the third and fourth arms includes a second region having a third end attached to the second end of the generally semi-circular region and a distal end oriented away from the other of the third and fourth arms and the second segments of the first and second arms are each attached to the first segments and extend away from the first base in third and fourth planes, respectively, that are generally parallel.

18. The holder of claim 17, wherein the second base is non-planar and facing surfaces of the first and second arms include knurling thereon.

19. The holder of claim 18, wherein the second base includes a surface that is convex on a side facing away from the first and second arms and the facing surfaces of the first and second arms are coated with a tacky material.

20. The holder of claim 19, wherein the first and second bases are connected by a support member disposed therebetween.
